(19) United States
(12) Patent Application Publication
(10) Pub. No.: US 2017/0249654 A1
(43) Pub. Date: Aug. 31, 2017

(54) INFORMATION APPARATUS, SERVER, METHOD OF POSTING ADVERTISEMENTS, METHOD OF PROVIDING SPECIAL BONUSES, AND COMPUTER READABLE MEDIUM

(71) Applicant: CASIO COMPUTER CO., LTD., Tokyo (JP)

(72) Inventor: Takashi Kawashimo, Tokyo (JP)

(21) Appl. No.: 15/390,859

(22) Filed: Dec. 27, 2016

(30) Foreign Application Priority Data
Feb. 29, 2016 (JP) 2016-037601

(51) Int. Cl. G06Q 30/02; G06Q 50/00

(52) U.S. Cl. CPC G06Q 30/0214; G06Q 50/01; G06Q 30/0277

(57) ABSTRACT

An information apparatus includes a beacon receiver and a controller. The beacon receiver receives beacon information. The controller posts advertisement information corresponding to the beacon information received by the beacon receiver to a Web site.

### CROSS-REFERENCE TO RELATED APPLICATION

This application is based upon and claims the benefit of priority from the prior Japanese Patent Application No. 2016-037601, filed on Feb. 29, 2016, the entire contents of which are incorporated herein by reference.

### BACKGROUND OF THE INVENTION

1. Field of the Invention

The present invention relates to an information apparatus, a server, a method of posting advertisements, a method of providing special bonuses, and a computer readable medium.

2. Description of Related Art

A Device provided with a video output unit is known that projects advertisement content on a screens formed so as to have a shape of human contour representing persons appearing in the advertisement content, to impress viewers (refer to JP 2011-150221 A, for example).

### SUMMARY OF THE INVENTION

Unfortunately, the technique disclosed in JP 2011-150221 A provides an advertisement that can only be viewed by visitors at the site, and thus cannot readily diffuse the advertisement.

An object of the present invention is to enhance diffusion of an advertisement.

To solve the object described above, in accordance with one aspect of the present invention, there is provided an information apparatus including:

a beacon receiver which receives beacon information; and

a controller which posts advertisement information corresponding to the beacon information received by the beacon receiver to a Web site.

In accordance with another aspect of the present invention, there is provided a server including:

a communication unit which receives identification information on advertisement information posted to a Web site and information on a poster of the advertisement information from a first information apparatus which receives beacon information and posts the advertisement information corresponding to the beacon information to the Web site, and receives identification information on advertisement information viewed by a user and information on a poster of the advertisement information from a second information apparatus which receives beacon information and with which the user views the advertisement information corresponding to the beacon information; and

a controller that provides a special bonus to the poster if the information which is posted to the Web site and which is sent from the first information apparatus matches the information which is viewed by the user and which is sent from the second information apparatus.

### BRIEF DESCRIPTION OF THE DRAWINGS

The above and other objects, advantages and features of the present invention will become more fully understood from the detailed description given hereinbelow and the appended drawings which are given byway of illustration only, and thus are not intended as a definition of the limits of the present invention, and wherein:

FIG. 1 illustrates the overall configuration of an advertisement system according to an embodiment.

FIG. 2 illustrates the outline of the operation of the advertisement system.

FIG. 3 is a block diagram illustrating the functional configuration of a digital signage in FIG. 1.

FIG. 4 illustrates the schematic configuration of a screen unit in FIG. 3.

FIG. 5 is a block diagram illustrating the functional configuration of a portable terminal in FIG. 1.

FIG. 6 is a block diagram illustrating the functional configuration of a server in FIG. 1.

FIG. 7 is a flow chart illustrating the process of transmitting beacon information executed by the controller in FIG. 3.

FIG. 8 is a flow chart illustrating the process of posting an advertisement executed by the controller in FIG. 5.

FIG. 9 is a flow chart illustrating the process of viewing an advertisement executed by the controller in FIG. 5.

FIG. 10 is a flow chart illustrating the process of providing a special bonus executed by the controller in FIG. 6.

### DESCRIPTION OF THE PREFERRED EMBODIMENT

Embodiments of the present invention will now be described in detail with reference to the accompanying drawings. In the embodiments, the information apparatus according to the present invention is a portable terminal 2, and the server according to the present invention is a server 3. The drawings should not be construed to limit the present invention.

[Configuration of Advertisement System 100]

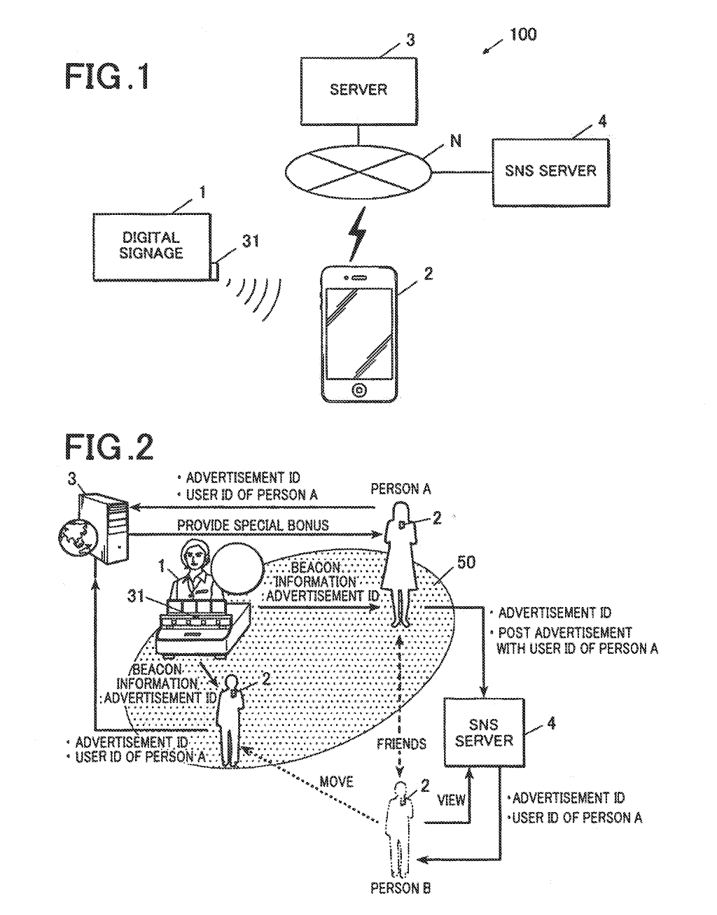

FIG. 1 illustrates the overall configuration of an advertisement system 100 according to an embodiment of the present invention. With reference to FIG. 1, the advertisement system 100 includes a digital signage 1, a portable terminal 2, a server 3, and a social networking service (SNS) server 4. A beacon transmitter 31 of the digital signage 1 and the portable terminal 2 can establish close-range wireless communication between each other via Bluetooth™ communication. The portable terminal 2 can communicate with the server 3 and the SNS server 4 via a communication network N including a local area network (LAN), a mobile communication network, and the Internet, for example. The digital signage 1 and the portable terminal 2 may be provided in any number.

FIG. 2 illustrates the outline of the operation of the advertisement system 100. With reference to FIG. 2, when a user (person A in FIG. 2) carrying the portable terminal 2 enters a communication area 50 of the beacon transmitter 31 during output of a content by the digital signage 1 installed in a store, the portable terminal 2 carried by the person A receives beacon information. In response to this, the portable terminal 2 automatically sends a user ID and an advertisement ID included in the received beacon information to the SNS server 4 to automatically post advertisement information corresponding to the advertisement ID to the SNS server 4 in the name of the person A. Another user (person B in FIG. 2) who is a friend of the person A views the post on the advertisement information with another portable terminal 2. In response to this, the SNS server 4 sends the advertisement ID corresponding to the viewed advertisement information and the user ID corresponding to the person A, who posted the advertisement information, to the portable terminal 2 carried by the person B. The person B visits the store and enters the communication area 50 of the beacon transmitter 31. The portable terminal 2 carried by the person B receives the beacon information and in response sends the advertisement ID in the beacon information and the user ID of the person A, who posted the advertisement information, to the server 3. The server 3 determines successful advertisement by the person A and rewards the person A with a special bonus.

The configuration and operation of the components of the advertisement system 100 will now be described.

[Configuration of Digital Signage 1]

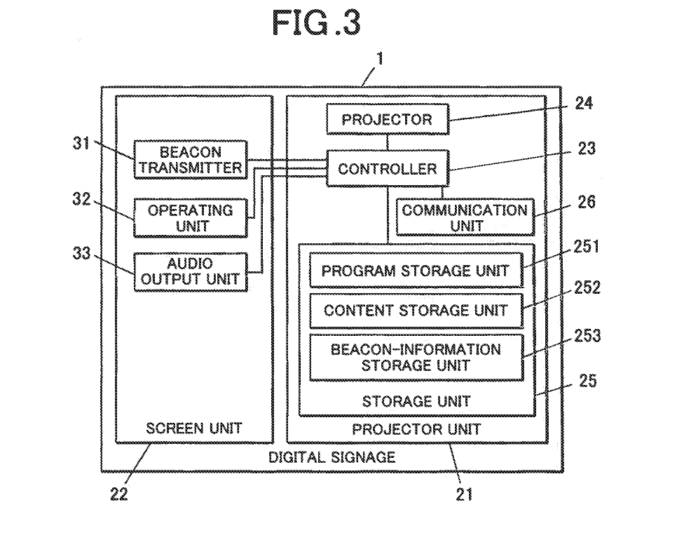

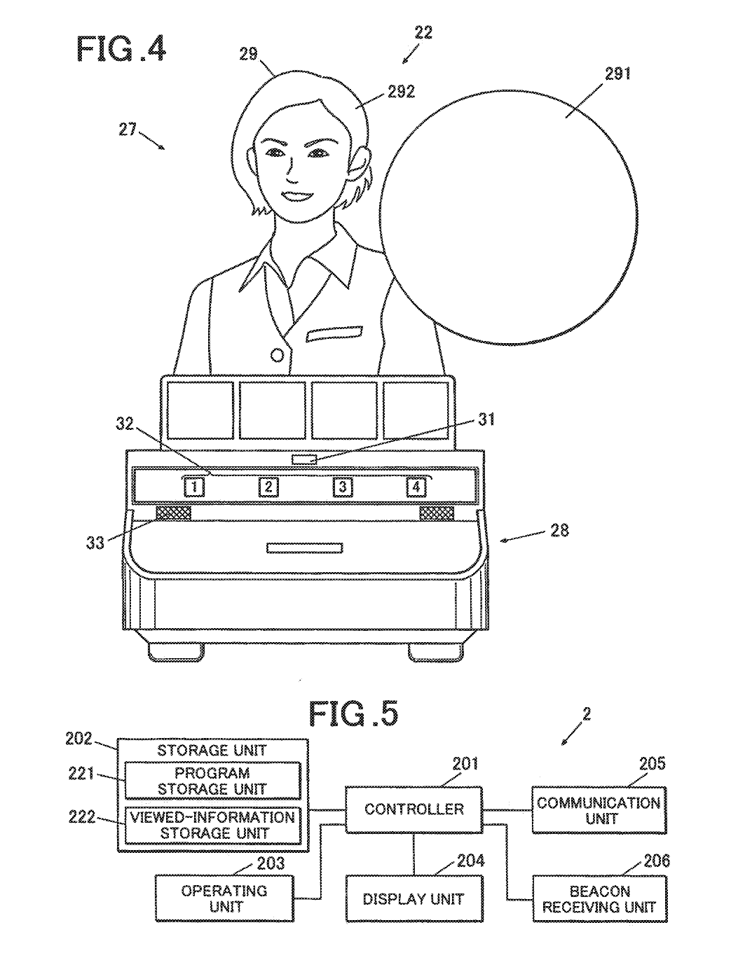

FIG. 3 is a block diagram illustrating the configuration of the main control of the digital signage 1 according to this embodiment. FIG. 4 is a front view of the schematic configuration of the screen unit 22 in FIG. 3. The digital signage 1 is installed in a store, for example, and outputs an advertisement content including description of commercial products to customers.

With reference to FIG. 3, the digital signage 1 includes a projector unit 21 that projects image light of the content, and a screen unit 22 that receives the image light from the projector unit 21 on the back face and projects the image light to the front face.

The projector unit 21 will now be described.

The projector unit 21 includes a controller 23, a projector 24, a storage unit 25, and a communication unit 26. The projector 24, the storage unit 25, and the communication unit 26 are connected to the controller 23, as illustrated in FIG. 3.

The controller 23 includes a central processing unit (CPU) and a memory (either not shown). The CPU executes various programs stored in the storage unit 25 to carry out predetermined calculation processes and control of the units. The memory provides a work area for the execution of the programs. The controller 23 operates in cooperation with programs stored in a program storage unit 251 of the storage unit 25 to execute the process of transmitting beacon information, as described below.

The projector 24 converts the image data corresponding to the content output from the controller 23 to image light and projects the image light to the screen unit 22. The projector 24 may be, for example, a digital light processing (DLP)™ projector including a digital micromirror device (DMD), which is a display device that forms a light image with light reflected at an array of micromirrors (1024×768 pixels for XGA) individually rotated by a predetermined degree at high speed between ON and OFF states.

The storage unit 25 includes a hard disk drive (HDD), a non-volatile semiconductor memory or the like. With reference to FIG. 3, the storage unit 25 includes a program storage unit 251, a content storage unit 252, and a beacon-information storage unit 253.

The program storage unit 251 stores a system program and other programs to be executed by the controller 23 and data required for the execution of the programs.

The content storage unit 252 stores content information or data to be output in connection with the content ID for identifying the content by the digital signage 1. The content information contains video data consisting of multiple frame images and audio data corresponding to the frame images, for example. Alternatively, the content information may include only image data (still image data or video image data).

The beacon-information storage unit 253 stores beacon information, which is associated with a content ID and transmitted from the beacon transmitter 31 during output of the content. In this embodiment, the beacon information contains an advertisement ID. The advertisement ID contains information for identifying the digital signage 1 to transmit the beacon information, the commercial product to be described in the content during transmission of the beacon information, and advertisement information posted to the SNS server 4.

The storage unit 25 stores a play back schedule of the content.

The communication unit 26 includes a modem, a router, and a network card, and establishes communication with external devices via the communication network N.

The screen unit 22 will now be described.

With reference to FIG. 4, the screen unit 22 includes an image forming unit 27 and a base 28 supporting the image forming unit 27.

The image forming unit 27 or screen includes a single light-transmissive plate 29, a film screen 291, and a printed film 292. The light-transmissive plate 29 is composed of an acrylic plate shaped into a human form, for example, and disposed substantially orthogonal to the projection direction of the image light. The film screen 291 for projection from behind, which is laminated with a Fresnel lens film, and the printed film 292, which depicts a human image, are bonded to the light-transmissive plate 29. The projector 24 projects an image on the image forming unit 27 in the area of the film screen 291. Alternatively, the film screen 291 may be bonded to the entire light-transmissive plate 29 such that the image is also projected on the human image.

The base 28 includes a beacon transmitter 31, operating unit 32 including buttons, and audio output units 33 that output audio signals, such as a loudspeaker.

The beacon transmitter 31 broadcasts predetermined beacon information established by the controller 23 at predetermined time intervals through a Bluetooth low energy (BLE) communication scheme.

The beacon transmitter 31, the operating unit 32 including buttons, and the audio output units 33 are connected to the controller 23, as illustrated in FIG. 3.

[Configuration of Portable Terminal 2]

FIG. 5 is block diagram illustrating the configuration of the main control of the portable terminal 2. The portable terminal 2 is an information processing device carried by a customer, such as a smartphone, a mobile phone, or a tablet. The portable terminal 2 includes a controller 201, a storage unit 202, an operating unit 203, a display unit 204, a communication unit 205, and a beacon receiver 206, as illustrated in FIG. 5.

The controller 201 includes a CPU and a memory (either not shown). The CPU executes the various programs stored in a program storage unit 221 of the storage unit 202 to carry out predetermined calculation processes and control of the units. The memory serves as a work area during execution of the programs. The controller 201 operates in cooperation with application programs stored in the program storage unit 221 of the storage unit 202 to execute various processes, such as posting of an advertisement and viewing of an advertisement, as described below. The controller 201 operates in cooperation with the application programs stored in the program storage unit 221, to function as a determiner. Furthermore, the controller 201 operates in cooperation with the application programs stored in the program storage unit 221 and the communication unit 205, to function as a retriever.

The storage unit 202 includes a non-volatile semiconductor memory. The storage unit 202 includes a program storage unit 221, as illustrated in FIG. 5. The program storage unit 221 stores a system program executed by the controller 201, a Web browser, an application program (hereinafter, referred to as a beacon application) for executing the process of posting an advertisement and viewing an advertisement, as described below, and data required for execution of such programs.

The storage unit 202 includes a viewed-information storage unit 222. The viewed-information storage unit 222 stores the advertisement ID corresponding to the advertisement information viewed by a user (and posted by another user) through access of the SNS server 4 with the portable terminal 2 in connection with the user ID corresponding to the user who posted the advertisement information.

The operating unit 203 includes various function keys, which are operated by a user, and outputs operation information on the keys to the controller 201. The operating unit 203 includes a touch panel including a grid of transparent electrodes and covering the surface of the display unit 204. The operating unit 203 detects the position pressed by a finger of the user or a stylus and outputs the positional information or operation information to the controller 201.

The display unit 204 includes a liquid crystal display (LCD) and displays various images corresponding to display control signals from the controller 201 on a screen.

The communication unit 205 is wirelessly connected to the communication network N via a base station or an access point, to communicate with external devices, such as the server 3 and the SNS server 4, connected to the communication network N.

The beacon receiver 206 establishes close-range wireless communication with, for example, an external beacon transmitter such as the beacon transmitter 31 of the digital signage 1 through a Bluetooth Low Energy (BLE) communication scheme, receives beacon information from the beacon transmitter, and outputs the beacon information to the controller 201. The beacon receiver 206 functions as a receiver.

[Configuration of Server 3]

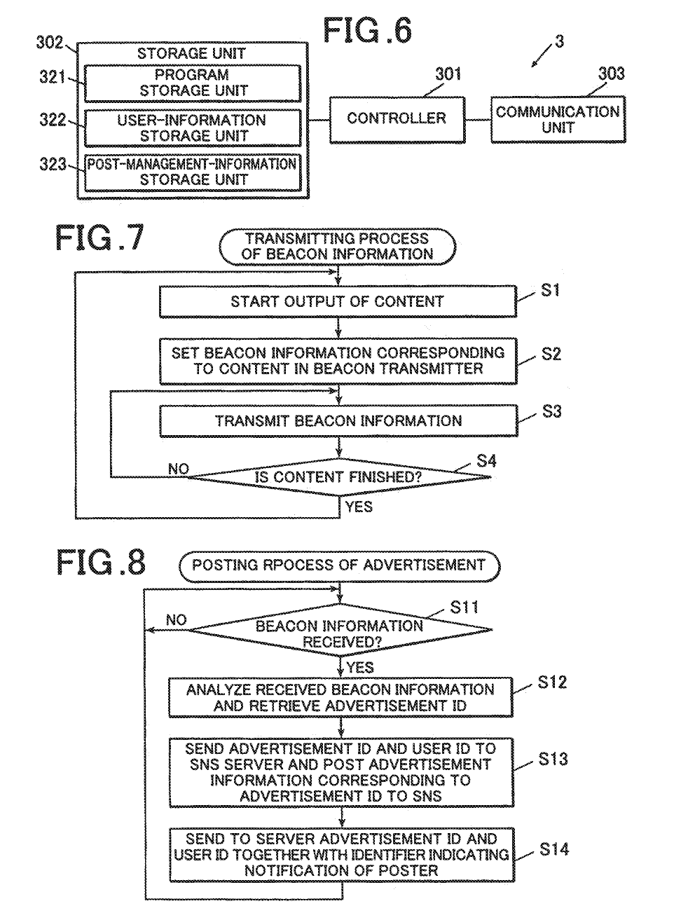

FIG. 6 is a block diagram illustrating the configuration of the main control of the server 3. The server 3 manages information such as user information on users who can use the advertisement system 100 and information involving posts made to the SNS server 4 by the beacon application in the portable terminal 2, and provides special bonuses to the user who successfully diffuses the advertisement (i.e., the user who posted advertisement information that was viewed by another user who later visited the store). With reference to FIG. 6, the server 3 includes a controller 301, a storage unit 302, and a communication unit 303.

The controller 301 includes a CPU and a memory (either not shown). The CPU executes the various programs stored in a program storage unit 321 of the storage unit 302, to carry out predetermined calculation processes and control of the units. The memory serves as a work area during execution of the programs. The controller 301 operates in cooperation with the programs stored in the program storage unit 321 of the storage unit 302, to execute the process of providing a special bonus, as described below, and functions as a special-bonus providing unit.

The storage unit 302 includes an HDD, a non-volatile semiconductor memory or the like. With reference to FIG. 6, the storage unit 302 includes the program storage unit 321. The program storage unit 321 stores a system program executed by the controller 301, various other programs, and data required for the execution of the programs.

The storage unit 302 includes a user-information storage unit 322.

The user-information storage unit 322 contains areas for items such as “user ID”, “password”, “name”, “e-mail address”, “sex” and “age” and stores user information containing these items registered with the portable terminal 2 or the like.

The storage unit 302 further includes a post-management-information storage unit 323. The post-management-information storage unit 323 contains areas for items such as “advertisement ID” and “user ID of the poster”, correlates the advertisement ID corresponding to the advertisement information posted to the SNS server 4 by the beacon application in the portable terminal 2 and the user ID of the poster, and stores these IDs.

The communication unit 303 includes a modem, a router, and a network card, and establishes communication with external devices via the communication network N. The communication unit 303 functions as first and second receivers.

[Configuration of SNS Server 4]

The SNS server 4 includes a controller, a storage unit, and a communication unit (all not shown). The controller and the programs stored in the storage unit operate in cooperation to provide a SNS Website. The storage unit of the SNS server 4 stores the advertisement ID in connection with the advertisement information of the commercial product specified by the advertisement ID. Upon reception of the advertisement ID and the user ID from the portable terminal 2 via the communication network N, the controller of the SNS server 4 determines the posting of the advertisement information corresponding to the advertisement ID by the user corresponding to the received user ID. The controller of the SNS server 4 then retrieves the advertisement information corresponding to the advertisement ID from the storage unit, and registers the advertisement information as a post by the user corresponding to the received user ID.

[Operation of Advertisement System 100]

The operation of the components of the advertisement system 100 will be described below.

The operation of the digital signage 1 will now be described.

FIG. 7 is a flow chart illustrating the process of transmitting beacon information executed by the digital signage 1. The process of transmitting beacon information is executed by the controller 23 in cooperation with the programs stored in the program storage unit 251 while the digital signage 1 is in a power-on state.

The controller 23 instructs the projector 24 and the audio output units 33 to output the content in accordance with a schedule (Step S1). For example, the controller 23 retrieves content information stored in the content storage unit 252 in accordance with a predetermined schedule and instructs the projector 24 to project (display) an image corresponding to the content on the image forming unit 27 on the basis of the video data in the retrieved content information. The controller 23 instructs the audio output units 33 to output audio corresponding to the content on the basis of the audio data in the retrieved video data.

The controller 23 refers to the beacon-information storage unit 253 and establishes beacon information corresponding to the content being output in the beacon transmitter 31 (Step S2). That is, the controller 23 sets in the beacon transmitter 31 beacon information containing the advertisement ID corresponding to the commercial product being described in the content being output.

The controller 23 instructs the beacon transmitter 31 to broadcast (transmit) the set beacon information (Step S3).

The controller 23 determines whether the content is finished (Step S4). If the content is not finished (NO in Step S4), the controller 23 carries out Step S3. If the content is finished (YES in Step S4), the controller 23 carries out Step S1 and starts to output the subsequent content.

The controller 23 repeats Steps S1 to S4 while the digital signage 1 is in a power-on state.

The operation of the portable terminal 2 will now be described.

FIG. 8 is a flowchart illustrating the process of posting an advertisement executed by the portable terminal 2. The process of posting an advertisement is executed by the controller 201 in cooperation with the beacon application stored in the program storage unit 221 while the user of the portable terminal 2 logs in to the advertisement system 100 with the beacon application.

The controller 201 waits for the beacon information received by the beacon receiver 206.

Upon reception of the beacon information by the beacon receiver 206 (YES in Step S11), the controller 201 analyzes the received beacon information and retrieves the advertisement ID (Step S12). The advertisement ID may be stored in advance in the storage unit 202 or may be retrieved through the network.

The controller 201 instructs the communication unit 205 to send the retrieved advertisement ID and the user ID of the user who logs in to the advertisement system 100 to post the advertisement information corresponding to the advertisement ID to an SNS (Step S13).

The controller 201 instructs the communication unit 205 to send the retrieved advertisement ID and the user ID of the user who logs in to the advertisement system 100 together with an identifier indicating the notification of a poster, to the server 3 (Step S14). The controller 201 then carries out Step S11.

The controller 201 repeats Steps S11 to S14 while the poster logs in to the advertisement system 100 with the beacon application.

In the process of posting an advertisement, when a user visits a shop and the portable terminal 2 receives the beacon information from the beacon transmitter 31 of the digital signage 1 installed in the store visited by the user carrying the portable terminal 2, the advertisement information corresponding to the content output from the digital signage 1 (the advertisement information on a commercial product described in the content, in this embodiment) is automatically posted to the SNS server 4. Thus, the advertisement can be readily diffused through content.

The process of viewing an advertisement executed by the portable terminal 2 will now be described.

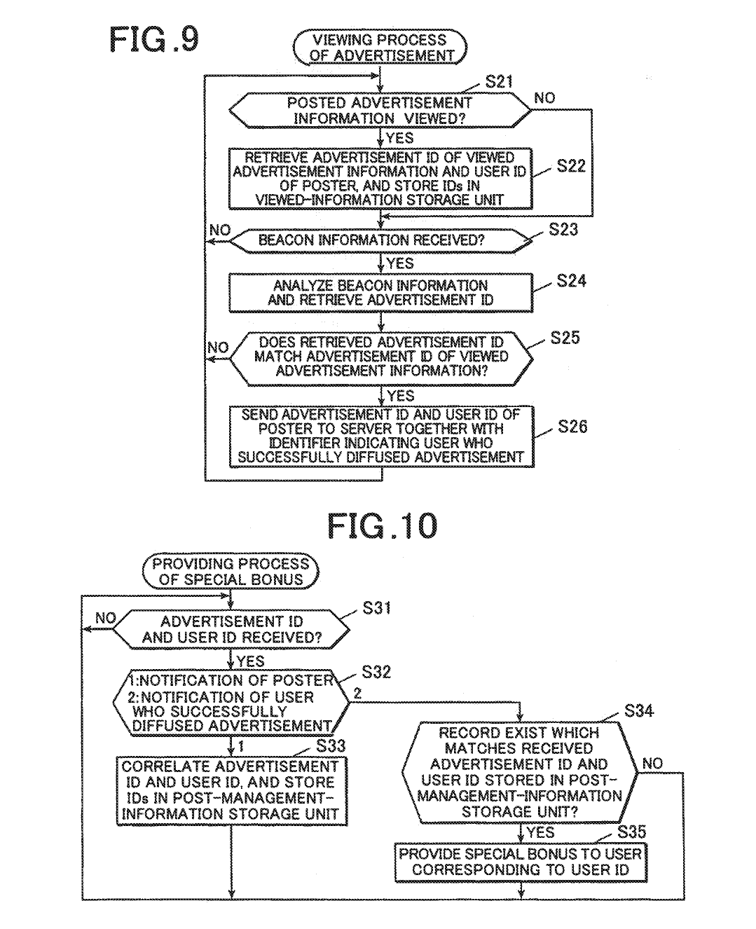

FIG. 9 is a flow chart illustrating the process of viewing an advertisement executed by the portable terminal 2. The process of viewing an advertisement is executed by the controller 201 in cooperation with the beacon application stored in the program storage unit 221 while the user carrying the portable terminal 2 logs in to the advertisement system. 100 with the beacon application.

The controller 201 determines whether the advertisement information posted to the SNS provided by the SNS server 4 is viewed by the user (Step S21). The user can access the SNS site provided by the SNS server 4 and view the post with the beacon application.

If the advertisement information posted to the SNS server 4 is not viewed by the user (NO in Step S21), the controller 201 carries out Step S23.

If the advertisement information posted to the SNS server 4 is viewed by the user (YES in Step S21), the controller 201 instructs the communication unit 205 to retrieve the advertisement ID of the viewed advertisement information and the user ID of the poster of the advertisement information from the SNS server 4 and stores them in the viewed-information storage unit 222 (Step S22). The controller 201 then carries out Step S23.

In Step S23, the controller 201 determines whether the beacon receiver 206 received the beacon information (Step S23). That is, the controller 201 determines whether the user carrying the portable terminal 2 entered the communication area of the beacon transmitter 31.

If the controller 201 determines that the beacon receiver 206 has not received the beacon information (NO in Step S23), the controller 201 carries out Step S21.

If the beacon receiver 206 received the beacon information (YES in Step S23), the controller 201 analyzes the received beacon information and retrieves the advertisement ID (Step S24).

The controller 201 determines whether the advertisement ID retrieved from the beacon information matches the advertisement ID stored in the viewed-information storage unit 222 (Step S25).

If the advertisement ID retrieved from the beacon information does not match the advertisement ID stored in the viewed-information storage unit 222 (NO in Step S25), the controller 201 carries out Step S21.

If the advertisement ID retrieved from the beacon information matches the advertisement ID stored in the viewed-information storage unit 222 (YES in Step S25), the controller 201 instructs the communication unit 205 to send the advertisement ID (i.e., the advertisement ID of the advertisement information viewed with the portable terminal 2) and the user ID (the user ID of the poster), which is stored in the viewed-information storage unit 222 in connection with the advertisement ID, together with an identifier indicating the user who successfully diffused the advertisement, to the server 3 (Step S26). The controller 201 then carries out Step S21.

The controller 201 repeats Steps S21 to S26 while the user of the portable terminal 2 logs in to the advertisement system 100 with the beacon application.

The operation of the server 3 will now be described.

FIG. 10 is a flow chart illustrating the process of providing a special bonus executed by the server 3. The process of providing a special bonus is executed by the controller 301 operating in cooperation with the programs stored in the program storage unit 321 in a power-on state of the server 3.

The controller 301 waits for the advertisement ID and the user ID received from the portable terminal 2 by the communication unit 303 (Step S31).

If the controller 301 determines that the advertisement ID and the user ID are received (YES in Step S31), the controller 301 determines whether the identifier indicates a poster or a user who successfully diffused the advertisement (Step S32) with reference to the identifier received together with the advertisement ID and the user ID.

If the controller 301 determines that the identifier indicates a poster (1 in Step S32), the controller 301 stores the received advertisement ID in connection with the user ID of the poster in the post-management-information storage unit 323 (Step S33). The controller 301 then carries out Step S31.

If the controller 301 determines that the identifier indicates a user who successfully diffused the advertisement (2 in Step S32), the controller 301 determines whether a record matching the received advertisement ID and the user ID is stored in the post-management-information storage unit 323 (Step S34).

If a record matching the received advertisement ID and the user ID is not stored in the post-management-information storage unit 323 (NO in Step S34), the controller 301 carries out Step S31.

If the controller 301 determines that a record matching the received advertisement ID and the user ID is stored in the post-management-information storage unit 323 (YES in Step S34), the controller 301 retrieves the user information corresponding to the user ID from the user-information storage unit 322 and provides a special bonus to the user corresponding to the user ID (Step S35). The controller 301 then carries out Step S31.

For example, the controller 301 instructs the communication unit 303 to send a coupon that can be exchanged with a prize to the e-mail address of the user. Alternatively, digital points may be provided. Alternatively, any other type of special bonus may be provided.

The controller 301 repeats Steps S31 to S35 in a power-on state of the server 3.

After another user who viewed the posted advertisement information visits the store and receives beacon information from the beacon transmitter 31, the user who posted the advertisement information receives a special bonus from the server 3 as a reward for the successful diffusion of the advertisement. Thus, the user who diffused the advertisement can be rewarded. Furthermore, the user is encouraged to visit the store and diffuse the advertisement.

As described above, when the beacon receiver 206 in the portable terminal 2 of the advertisement system 100 receives beacon information from the digital signage 1, the controller 201 instructs the communication unit 205 to send the advertisement ID in the received beacon information and the user ID of the user of the portable terminal 2, to the SNS server 4 and automatically posts the advertisement information corresponding to the advertisement ID in the beacon information to an SNS site provided by the SNS server 4.

When the portable terminal 2 enters the communication area of beacon information and receives the beacon information, the portable terminal 2 automatically posts the advertisement information corresponding to the beacon information, to the SNS site. Thus, the advertisement is readily diffused.

The controller 201 of the portable terminal 2 instructs the communication unit 205 to send the advertisement ID of the posted advertisement information and the user ID, which is the information on the poster of the advertisement information, to the server 3.

This notifies the server 3 about the posting of advertisement information by the user.

The controller 201 of the portable terminal 2 instructs the communication unit 205 to retrieve the advertisement ID of the advertisement information viewed by the user and the user ID of the poster of the advertisement information from the SNS server 4 and stores these IDs in the viewed-information storage unit 222. When the beacon receiver 206 receives beacon information, the controller 201 refers to the viewed-information storage unit 222 and determines whether a user viewed the advertisement information corresponding to the advertisement ID in the received beacon information. If the controller 201 determines that the advertisement has been viewed by a user, the controller 201 sends the advertisement ID and the user ID stored in the viewed-information storage unit 222 to the server 3.

Thus, when the portable terminal 2 receives the beacon information corresponding to the advertisement information viewed by the user, i.e., when the user who viewed the posted advertisement information visits the store, the advertisement ID of the advertisement information and the user ID of the poster can be notified to the server 3.

The advertisement information corresponding to the beacon information involves the content output by the digital signage 1 during transmission of the beacon information. Thus, the advertisement information involving the content provided by the digital signage 1 can be readily diffused.

The controller 301 of the server 3 instructs the communication unit 303 to receive the advertisement ID and the user ID from the portable terminal 2 that posted the advertisement information to the SNS site provided by the SNS server 4 and stores these IDs in the post-management-information storage unit 323. The controller 301 determines whether the advertisement ID and the user ID sent from the portable terminal 2 used for viewing of the advertisement information in the SNS site provided by the SNS server 4 by the communication unit 303 match the advertisement ID and the user ID stored in the post-management-information storage unit 323. If the IDs match, the controller 301 provides a special bonus to the user corresponding to the user ID.

Thus, the special bonus can be provided to the user who posted the advertisement information after another user who viewed the posted advertisement information visits the store and receives the beacon information from the beacon transmitter 31. This encourages users to visit the store and diffuse the advertisement.

The embodiment described above, which exemplifies an advertisement system according to the present invention, should not be construed to limit the present invention.

For example, in the embodiments described above, when the portable terminal 2 receives the beacon information from the beacon transmitter 31 and posts the advertisement information to the SNS server 4 and when the portable terminal 2 used by another user who viewed the posted advertisement information receives the beacon information from the beacon transmitter 31, the advertisement ID and the information on the poster of the advertisement information are sent to the server 3 and the server 3 provides a special bonus to the poster on the basis of information from the both users. Alternatively, the special bonus may be provided on the basis of one of the users. For example, the advertisement is diffused as a result of the portable terminal 2 receiving the beacon information from the beacon transmitter 31 and posting the advertisement information to the SNS server 4. Thus, the special bonus may be provided only on the basis of the information transmitted at this time. The poster who successfully diffused the advertisement can be identified on the basis of only the advertisement ID and the information on the poster of the advertisement information sent when the portable terminal 2 carried by the user who viewed the advertisement information and visits the store receives the beacon information from the beacon transmitter 31. Thus, the special bonus may be provided on the basis of only the advertisement information and the information on the poster sent at this time.

In the embodiments described above, the advertisement information is posted to an SNS. Alternatively, the advertisement information may be posted to any Web site other than an SNS.

In the embodiments described above, the advertisement information corresponding to the advertisement ID is preliminarily provided by the SNS server 4. Alternatively, the advertisement information corresponding to the advertisement ID may be generated with the beacon application in the portable terminal 2 and sent to the SNS server 4.

In the embodiments described above, the advertisement information on the commercial product described in the content output from the digital signage 1 is posted to the SNS server 4. Alternatively, the advertisement information to be posted may be any type of information relating to the content output from the digital signage 1.

The detailed configuration and operation of the individual components of the advertisement system may be modified in various ways without departing from the scope of the invention.

The embodiments described above should not be construed to limit the present invention, and the claims and other equivalents thereof are included in the scope of the invention.

What is claimed is:

1. An information apparatus comprising:
a beacon receiver which receives beacon information; and
a controller which posts advertisement information corresponding to the beacon information received by the beacon receiver to a Web site.

2. The information apparatus according to claim 1, wherein the Web site comprises a social networking service (SNS) Web site.

3. The information apparatus according to claim 1, further comprising:
a communication unit which sends identification information on the advertisement information posted by the controller and user information on a user of the information apparatus as information on a poster of the advertisement information, to a server that provides a special bonus to the poster of the advertisement information.

4. The information apparatus according to claim 3, further comprising:
a retriever which retrieves identification information on the advertisement information viewed by a user and information on a poster of the advertisement information, wherein,
when the beacon receiver receives the beacon information, the controller determines whether the user viewed the advertisement information corresponding to the received beacon information, based on the identification information on the advertisement information retrieved by the retriever, and
when the controller determines that the user viewed the advertisement information, the communication unit sends the identification information on the advertisement information and the information on the poster retrieved by the retriever to a server that provides a special bonus to the poster of the advertisement information.

5. The information apparatus according to claim 1, wherein,
the beacon information is transmitted from a beacon transmitter provided in a content outputting unit which outputs an advertisement content, and
the advertisement information corresponding to the beacon information comprises advertisement information relating to the advertisement content output from the content outputting unit when the beacon information is transmitted.

6. A server comprising:
a communication unit which receives identification information on advertisement information posted to a Web site and information on a poster of the advertisement information from a first information apparatus which receives beacon information and posts the advertisement information corresponding to the beacon information to the Web site, and receives identification information on advertisement information viewed by a user and information on a poster of the advertisement information from a second information apparatus which receives beacon information and with which the user views the advertisement information corresponding to the beacon information; and
a controller that provides a special bonus to the poster if the information which is posted to the Web site and which is sent from the first information apparatus matches the information which is viewed by the user and which is sent from the second information apparatus.

7. A method of posting an advertisement, comprising:
a) receiving beacon information; and
b) posting to a Web site advertisement information corresponding to the beacon information received in step a).

8. A method of providing a special bonus, comprising:
a) receiving identification information on advertisement information posted to a Web site and information on a poster of the advertisement information from a first information apparatus which receives beacon information and posts the advertisement information corresponding to the beacon information to the Web site;
b) receiving identification information on advertisement information viewed by a user and information on a poster of the advertisement information from a second information apparatus which receives beacon information and with which the user views the advertisement information corresponding to the beacon information; and
c) providing a special bonus to the poster if the information received in step a) matches the information received in step b).

9. A non-transitory computer readable medium storing a program thereon which is executed by a computer, the program making the computer:
a) receive beacon information; and
b) post advertisement information corresponding to the beacon information received in step a) to a Web site.

10. A non-transitory computer readable medium storing a program thereon which is executed by a computer, the program making the computer:
a) receive identification information on advertisement information posted to a Web site and information on a poster of the advertisement information from a first information apparatus that receives beacon information and posts the advertisement information corresponding to the beacon information to the Web site;
b) receive identification information on advertisement information viewed by a user and information on a poster of the advertisement information from a second information apparatus which receives beacon information and with which the user views the advertisement information corresponding to the beacon information; and
c) provide a special bonus to the poster if the information received in step a) matches the information received in step b).
